(19) United States
(12) Patent Application Publication
(10) Pub. No.: US 2025/0170551 A1
(43) Pub. Date: May 29, 2025

(54) SORBENTS FOR REMOVAL OF MERCURY AND OTHER CONTAMINANTS

(71) Applicant: CALGON CARBON CORPORATION, Moon Township, PA (US)

(72) Inventors: Philippe WESTREICH, Pittsburgh, PA (US); Steven L. BUTTERWORTH, Moon Township, PA (US); Catherine KRESS, Moon Township, PA (US)

(73) Assignee: CALGON CARBON CORPORATION, Moon Township, PA (US)

(21) Appl. No.: 18/960,872

(22) Filed: Nov. 26, 2024

Related U.S. Application Data
(60) Provisional application No. 63/602,945, filed on Nov. 27, 2023.

(51) Int. Cl. B01J 20/02; B01D 53/64; B01D 53/81; B01J 20/08; B01J 20/10; B01J 20/14; B01J 20/16; B01J 20/18; B01J 20/20; B01J 20/32

(52) U.S. Cl. CPC B01J 20/0288; B01D 53/64; B01D 53/81; B01J 20/0218; B01J 20/0237; B01J 20/0281; B01J 20/08; B01J 20/103; B01J 20/14; B01J 20/165; B01J 20/18; B01J 20/20; B01J 20/3204; B01J 20/3236; B01D 2253/102; B01D 2253/104; B01D 2253/108; B01D 2253/25; B01D 2257/602; B01D 2258/06

(57) ABSTRACT

The present disclosure describes sorbent material products for the removal of mercury and other toxic gases. These sorbent material products may include a halide, copper, and molybdenum. Methods of preparing the sorbent material products disclosed herein and methods of removing mercury from a fluid stream using the same are also provided.

### CROSS-REFERENCE TO RELATED APPLICATIONS

This application claims priority to U.S. Provisional Application No. 63/602,945, which was filed on Nov. 27, 2023, and is hereby incorporated by reference herein in its entirety.

### BACKGROUND

Sorbents such as activated carbon have long been used to remove toxic gases and vapors from fluid streams. For example, activated carbons that are incorporated into a filter are useful for removing noxious agents from fluids in the gas phase, for example breathing air or exhaust gases. This is common in applications such as gas mask filters, collective filters, and other applications. Activated carbons used to remove noxious agents are often treated with various components that adsorb, catalyze, react, or otherwise interact with noxious gases that would otherwise not be removed by contacting the noxious gases with untreated activated carbons. Prior formulations contain chromium and/or other agents impregnated on an activated carbon, and function as adsorbents effective in removing a variety of toxic materials from a fluid stream. In many applications, it is desirable that a single impregnated adsorbent be effective against a range of toxic agents in a fluid stream.

The use of impregnated activated carbon adsorbents in respirators and collective filters, either for military or industrial applications, requires special considerations regarding the toxicity and carcinogenicity of the impregnants to the user. These considerations eliminate a large number of prior art potential impregnants from use in respirator and collective filter applications. This is especially the case with hexavalent chromium; for example, the wearer of a protective mask which employs a filter containing hexavalent chromium may suffer adverse consequences due to exposure to this potential health hazard. U.S. Pat. No. 5,492,882 describes chromium-free activated carbons for the removal of toxic vapors; however, there remains a need for sorbents which can remove mercury in addition to other toxic and/or noxious contaminants.

Mercury vapor is toxic and must be removed from air to make it suitable for breathing. Previous multi-gas sorbents are not able to combine the strict organic vapor removal requirements with mercury removal, and thus previous sorbents are not capable of effectively removing both organic vapors and mercury from fluid streams. There remains a need for high-performance sorbents which can remove multiple contaminants, including mercury, from fluid streams.

### SUMMARY

In some aspects, the techniques described herein relate to a sorbent material product, including: a sorbent material having a surface deposition including: about 0.1 wt. % to about 10 wt. % of a halide, about 0.1 wt. % to about 20 wt. % copper, and about 0.1 wt. % to about 10 wt. % molybdenum.

In some aspects, the techniques described herein relate to a sorbent material product, wherein the sorbent material includes activated carbon, reactivated carbon, natural zeolite, synthetic zeolite, silica, silica gel, alumina, diatomaceous earths, and combinations thereof.

In some aspects, the techniques described herein relate to a sorbent material product, wherein the halide includes chloride, iodide, or a combination thereof.

In some aspects, the techniques described herein relate to a sorbent material product, including about 0.1 wt. % to about 2 wt. % chloride.

In some aspects, the techniques described herein relate to a sorbent material product, including about 0.4 wt. % to about 7 wt. % iodide.

In some aspects, the techniques described herein relate to a sorbent material product, further including about 0.5 wt. % to about 5 wt. % sulfate.

In some aspects, the techniques described herein relate to a sorbent material product, having a mercury breakthrough time of at least about 480 minutes.

In some aspects, the techniques described herein relate to a sorbent material product, having a mercury breakthrough time of at least about 1000 minutes.

In some aspects, the techniques described herein relate to a sorbent material product, having an ammonia breakthrough time of at least about 30 minutes.

In some aspects, the techniques described herein relate to a sorbent material product, having a sulfur dioxide breakthrough time of at least about 40 minutes.

In some aspects, the techniques described herein relate to a sorbent material product, having a cyclohexane breakthrough time of at least about 30 minutes.

In some aspects, the techniques described herein relate to a sorbent material product, having a CCl4 breakthrough time of at least about 10 minutes.

In some aspects, the techniques described herein relate to a method of preparing a sorbent material product, including: forming an aqueous solution including a halide, copper, and molybdenum; and contacting a sorbent material feedstock with the aqueous solution to form the sorbent material product.

In some aspects, the techniques described herein relate to a method, wherein the sorbent material feedstock includes activated carbon, reactivated carbon, natural zeolite, synthetic zeolite, silica, silica gel, alumina, diatomaceous earths, or combinations thereof.

In some aspects, the techniques described herein relate to a method, wherein the sorbent material feedstock includes activated carbon formed from bituminous coal, sub-bituminous coal, lignite coal, anthracite coal, peat, nut shells, pits, coconut, babassu nut, macadamia nut, dende nut, peach pit, cherry pit, olive pit, walnut shell, wood, bagasse, rice hulls, corn husks, wheat hulls, polymers, resins, petroleum pitches, or combinations thereof.

In some aspects, the techniques described herein relate to a method, wherein the sorbent material product includes about 0.1 wt. % to about 10 wt. % of a halide, about 0.1 wt. % to about 20 wt. % copper, and about 0.1 wt. % to about 10 wt. % molybdenum.

In some aspects, the techniques described herein relate to a method, wherein the halide includes chloride, iodide, or a combination thereof.

In some aspects, the techniques described herein relate to a method of removing mercury from a fluid stream, including: contacting the fluid stream with a sorbent material product including a sorbent material having a first surface deposition including: about 0.1 wt. % to about 10 wt. % of a halide, about 0.1 wt. % to about 20 wt. % copper, and about 0.1 wt. % to about 10 wt. % molybdenum.

In some aspects, the techniques described herein relate to a method, wherein the sorbent material includes activated carbon, reactivated carbon, natural zeolite, synthetic zeolite, silica, silica gel, alumina, diatomaceous earths, and combinations thereof.

In some aspects, the techniques described herein relate to a method, wherein the halide includes chloride, iodide, or a combination thereof.

In some aspects, the techniques described herein relate to a method, wherein the sorbent material product has a mercury breakthrough time of at least about 480 minutes.

In some aspects, the techniques described herein relate to a method, wherein the sorbent material product has a mercury breakthrough time of at least about 1000 minutes.

In some aspects, the techniques described herein relate to a method, wherein the mercury is in the form of elemental mercury, mercury-containing compounds, or a combination thereof.

In some aspects, the techniques described herein relate to a method, further including removing ammonia, sulfur dioxide, cyclohexane, CCl4, or combinations thereof from the fluid stream.

In some aspects, the techniques described herein relate to a method, wherein the sorbent material product has an ammonia breakthrough time of at least about 30 minutes.

In some aspects, the techniques described herein relate to a method, wherein the sorbent material product has a sulfur dioxide breakthrough time of at least about 40 minutes.

In some aspects, the techniques described herein relate to a method, wherein the sorbent material product has a cyclohexane breakthrough time of at least about 30 minutes.

In some aspects, the techniques described herein relate to a method, wherein the sorbent material product has a CCl4 breakthrough time of at least about 10 minutes.

### DETAILED DESCRIPTION

Before the present compositions and methods are described, it is to be understood that this invention is not limited to the particular processes, compositions, or methodologies described, as these may vary. It is also to be understood that the terminology used in the description is for the purpose of describing the particular versions or embodiments only, and is not intended to limit the scope of the present invention, which will be limited only by the appended claims. Unless defined otherwise, all technical and scientific terms used herein have the same meaning as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference in their entirety. Nothing herein is to be construed as an admission that the invention is not entitled to antedate such disclosure by virtue of prior invention.

It must also be noted that as used herein and in the appended claims, the singular forms “a,” “an,” and “the” include plural reference unless the context clearly dictates otherwise. Thus, for example, reference to “a combustion chamber” is a reference to “one or more combustion chambers” and equivalents thereof known to those skilled in the art, and so forth.

As used herein, the term “about” means plus or minus 10% of the numerical value of the number with which it is being used. Therefore, “about 50%” means in the range of 45%-55% and also includes exactly 50%.

As used herein, the term “sorbent material” refers to an adsorbent compound which may serve as a precursor or intermediate to a final sorbent. For example, sorbent materials include, but are not limited to, activated carbon, natural zeolite, synthetic zeolite, silica, silica gel, alumina, zirconia, diatomaceous earths, and metal organic frameworks.

As used herein, the term “sorbent” is meant to encompass a sorbent material which has, in some embodiments, been treated with thermal, chemical, or other means.

Various embodiments of the invention are directed to sorbents for removal of noxious or toxic gases from air or other gas streams. Other embodiments are directed to methods for producing such sorbents and filter apparatuses including these sorbents.

There remains a need for sorbents which can remove mercury along with other contaminants. U.S. Pat. No. 5,492,882, which is hereby incorporated by reference in its entirety, describes chromium-free activated carbons for the removal of toxic vapors; however, the mercury removal performance of these and other prior sorbents is poor, and an effective mercury-removal sorbent that retains high performance for the removal of other contaminants has yet to be realized.

In some embodiments, there is provided a composition for removing contaminants such as mercury and mercury-containing compounds from a fluid stream. In some embodiments, the fluid stream is a gas stream. The composition can include a first sorbent, which in some embodiments includes a sorbent material. In some embodiments, a sorbent material, such as for example activated carbon, is treated or processed to provide a final sorbent.

Embodiments are not limited to any particular sorbent material. For example, the sorbent material may be any of activated carbon, reactivated carbon, natural and synthetic zeolite, silica, silica gel, alumina, diatomaceous earths, zirconia, and the like and combinations thereof. In some embodiments, the sorbent material may include metal organic frameworks, alone or in combination with others of the above-listed sorbent materials. In certain embodiments, the sorbent material may be an activated carbon or reactivated carbon. In such embodiments, the activated carbon may be obtained from any source and can be made from a variety of starting materials. For example, suitable materials for production of activated carbon include, but are not limited to, coals of various ranks such as anthracite, semi-anthracite, bituminous, sub-bituminous, brown coals, or lignites; nutshells, such as coconut shell; wood; vegetables such as rice hull or straw; residues or by-products from petroleum processing; and natural or synthetic polymeric materials. The carbonaceous material may be processed into carbon adsorbents by any conventional thermal or chemical methods known in the art and will inherently impart different surface areas and pore volumes depending on the starting materials and processing used. In particular embodiments, the activated carbon may be a coal based activated carbon, and in some embodiments, the starting material may be bituminous coal.

The sorbent material products described herein can be used to adsorb or otherwise remove, such as by catalysis, reaction, or other means, various toxic or noxious gases and organic vapors from streams of fluid such as, for example, air. A wide variety of toxic or noxious gases can be removed by these sorbents such as, for example, HCN, CNCl, H₂S, Cl₂, SO₂, NO, NO₂, formaldehyde, and NH₃. Similarly, various organic vapors such as, for example, CCl₄, cyclohexane, benzene, toluene, acetone, organic solvents, and the like can be adsorbed by the sorbents described herein. Therefore, in some embodiments, the sorbent can be provided in fixed beds through which streams of gas that include or potentially include toxic or noxious contaminant gases are passed. In other embodiments, the sorbent can be contained within a housing that is attached to, for example, respirators, gas masks, compressed breathing air devices, and the like through which gas streams including potentially toxic or noxious contaminates are passed.

There is provided a sorbent material product which includes a sorbent material having a surface deposition including about 0.1 wt. % to about 10 wt. % of a halide, about 0.1 wt. % to about 20 wt. % copper, and about 0.1 wt. % to about 10 wt. % molybdenum, relative to the total weight of the sorbent material.

The sorbent material may include activated carbon, reactivated carbon, natural zeolite, synthetic zeolite, silica, silica gel, alumina, diatomaceous earths, and combinations thereof. As described herein, the sorbent material may be derived from any source. For example, the sorbent material may include activated carbon or reactivated carbon formed from bituminous coal, sub-bituminous coal, lignite coal, anthracite coal, peat, nut shells, pits, coconut, babassu nut, macadamia nut, dende nut, peach pit, cherry pit, olive pit, walnut shell, wood, bagasse, rice hulls, corn husks, wheat hulls, polymers, resins, petroleum pitches, or combinations thereof.

In some embodiments, the sorbent material product may include about 0.1 wt. %, about 0.2 wt. %, about 0.3 wt. %, about 0.4 wt. %, about 0.5 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, or any value contained within a range formed by any two of the preceding values, of a halide. The halide may include chloride, iodide, or a combination thereof.

In some embodiments, the sorbent material product may include copper in an amount of about 0.1 wt. %, about 0.5 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, or any value contained within a range formed by any two of the preceding values.

In some embodiments, the sorbent material product may include molybdenum in an amount of about 0.1 wt. %, about 0.5 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, or any value contained within a range formed by any two of the preceding values.

In some embodiments, the sorbent material product further includes about 0.5 wt. % to about 5 wt. % sulfate, such as about 0.5 wt. %, about 1 wt. %, about 2 wt. %, about 3 wt. %, about 4 wt. %, about 5 wt. %, or any value contained within a range formed by any two of the preceding values.

In some embodiments, the sorbent material product may be evaluated for its efficacy in removing mercury or other contaminants from a fluid stream. One such method of evaluation is the measurement of breakthrough time, which represents the time after which the composition can no longer absorb or adsorb the contaminant of interest. In some embodiments, the sorbent material product has a mercury breakthrough time of at least about 450 minutes, about 480 minutes, about 500 minutes, about 600 minutes, about 700 minutes, about 800 minutes, about 900 minutes, about 1000 minutes, such as about 1000 minutes, about 1200 minutes, about 1400 minutes, about 1600 minutes, about 1800 minutes, about 2000 minutes, about 2200 minutes, about 2400 minutes, about 2600 minutes, about 2800 minutes, about 3000 minutes, about 3200 minutes, about 3400 minutes, about 3600 minutes, any value contained within a range formed by any two of the preceding values, and so forth. In some embodiments, the sorbent material product is capable of removing mercury from a fluid stream in addition to removing other contaminants such as acid gases, basic gases, organic vapors, and the like.

In some embodiments, the sorbent material product has an ammonia breakthrough time of at least about 30 minutes, such as about 30 minutes, about 35 minutes, about 40 minutes, about 45 minutes, about 50 minutes, about 55 minutes, about 60 minutes, about 70 minutes, about 80 minutes, and so forth. In some embodiments, the sorbent material product has a sulfur dioxide breakthrough time of at least about 40 minutes, such as about 40 minutes, about 45 minutes, about 50 minutes, about 55 minutes, about 60 minutes, about 70 minutes, about 80 minutes, and so forth.

In some embodiments, the sorbent material product of the present disclosure provides significantly improved mercury removal, relative to sorbents of a similar composition which do not include a halide. In some embodiments, the sorbent material product provides at least a 10-fold increase in mercury removal performance relative to sorbents which do not contain a halide as described herein.

In some embodiments, the sorbent material product has a cyclohexane breakthrough time of at least about 30 minutes, such as about 30 minutes, about 40 minutes, about 50 minutes, about 60 minutes, about 70 minutes, about 80 minutes, and so forth.

In some embodiments, the sorbent material product has a CCl₄ breakthrough time of at least about 10 minutes, such as about 10 minutes, about 15 minutes, about 20 minutes, about 25 minutes, about 30 minutes, about 40 minutes, about 50 minutes, about 60 minutes, and so forth.

Certain embodiments are directed to methods for making the composition described above. In some embodiments, the methods may include one or more steps of impregnating a sorbent material with an additive. As described above, the sorbent material may include any of activated carbon, reactivated carbon, natural and synthetic zeolite, silica, silica gel, alumina, diatomaceous earths, zirconia and the like and combinations thereof. The step of impregnating is well known in the art and can be carried out in any number of ways. Typically, impregnating includes the step of contacting a sorbent material, by immersion or other means, with an impregnation solution containing one or more additives that are dissolved or dispersed in the impregnating solution. The impregnating solution may include one or more additives that will become associated with the sorbent material while the sorbent material is in contact with the impregnating solution. Impregnating can be carried out in one or more impregnating steps. For example, in some embodiments, all of the additives incorporated onto the sorbent material may be included in the impregnating solution such that all of the additives can become associated with the sorbent material in a single impregnating step. In other embodiments, the impregnating solution may include a single additive and a separate impregnating step may be necessary for each additive incorporated onto the sorbent material. In still other embodiments, impregnating can be carried out by impregnating with a first impregnating solution including two or more additives and impregnating with a second impregnating solution including one or more additives. In yet other embodiments, impregnating can be carried out using three or more impregnating steps in which each impregnating solution includes one, two, three, four, or more additives. In some embodiments, impregnating the sorbent material with an additive as described herein forms an impregnated sorbent material.

In some embodiments, there is provided a method of preparing a sorbent material product which includes forming an aqueous solution including a halide, copper, and molybdenum; and contacting a sorbent material feedstock with the aqueous solution to form the sorbent material product.

In some embodiments, the sorbent material feedstock includes activated carbon, reactivated carbon, natural zeolite, synthetic zeolite, silica, silica gel, alumina, diatomaceous earths, and combinations thereof. In some embodiments, the sorbent material feedstock includes activated carbon or reactivated carbon formed from bituminous coal, sub-bituminous coal, lignite coal, anthracite coal, peat, nut shells, pits, coconut, babassu nut, macadamia nut, dende nut, peach pit, cherry pit, olive pit, walnut shell, wood, bagasse, rice hulls, corn husks, wheat hulls, polymers, resins, petroleum pitches, or combinations thereof.

In certain embodiments, the liquid portion of the impregnating solution in which the halide, copper, and molybdenum are dissolved or dispersed may be water. In other embodiments, the liquid portion of the impregnating solution may be an aqueous solution of water and a secondary component provided to aid dissolution of the compound into the impregnating solution. The impregnating solution may further include other additives. The aqueous solution may include an amount of the halide, copper, and molybdenum such that the resulting sorbent material product includes about 0.1 wt. % to about 10 wt. % of a halide, about 0.1 wt. % to about 20 wt. % copper, and about 0.1 wt. % to about 10 wt. % molybdenum as described herein. In some embodiments, impregnating the sorbent material feedstock may be performed in one step or in multiple sequential steps using multiple solutions.

The methods of some embodiments may include the step of drying the sorbent material after impregnating. Drying is typically carried out after impregnating and/or between impregnating steps when the methods include more than one impregnating step. Drying can be carried out by any means, and in some embodiments, drying can be carried out in an oven, kiln, or fluid bed. In certain embodiments, the methods may include the step of moisturizing the dried activated carbon. Moisturizing can be carried out by any means including, for example, spraying water onto the adsorbent. In some embodiments, moisturizing results in an adsorbent having a moisture content up to about 25%, and in other embodiments, moisturizing may result in an adsorbent having a moisture content of about 2% to about 10%. In further embodiments, moisturizing results in an adsorbent having a moisture content of about 4% to about 8%. In some embodiments, drying the impregnated sorbent material forms a dried impregnated sorbent material.

In some embodiments, the sorbent material product has an apparent density of about 0.5 g/cc to about 0.8 g/cc, such as about 0.5 g/cc, about 0.6 g/cc, about 0.7 g/cc, about 0.8 g/cc, or any value contained within a range formed by any two of the preceding values.

In some embodiments, there is provided a method of removing mercury from a fluid stream. The method can include providing a composition as described herein (such as a sorbent material product having a first surface deposition including about 0.1 wt. % to about 10 wt. % of a halide, about 0.1 wt. % to about 20 wt. % copper, and about 0.1 wt. % to about 10 wt. % molybdenum) and contacting the initial fluid stream with the sorbent material product, thereby removing mercury and optionally other contaminants from the fluid stream. In some embodiments, contacting the fluid stream with the sorbent material product includes passing the fluid stream over or through the composition by any means known to those skilled in the art. The mercury in the fluid stream may be in the form of elemental mercury, mercury-containing compounds, or a combination thereof.

In some embodiments, the fluid stream contains a lower concentration of mercury or mercury-containing compounds after contacting the fluid stream with the sorbent material product. The concentration of mercury and mercury-containing compounds in the fluid stream may be measured by any method known to those skilled in the art.

In some embodiments, the method further includes removing ammonia, sulfur dioxide, organic vapors, or combinations thereof from the fluid stream, in addition to removing mercury. In some embodiments, the fluid stream contains a lower concentration of mercury, ammonia, sulfur dioxide, organic vapors, or combinations thereof after being contacted with the sorbent material product described herein.

Additional embodiments are directed to filters for purifying streams of fluid using the sorbents described above. Such embodiments are not limited to particular types of filters. In some embodiments, the filter may be an air filter for civilian or military applications, for example, a personal protection gas mask filter, first responder mask filter, or collective protection filter. In other embodiments, the filter may be an air filter for industrial applications such as, for example, automotive cabin air purification systems.

The filters of various embodiments may have any design and may at least include a housing, including a compartment configured to hold the sorbent and allow streams of fluid to flow over or through the sorbent. Such filters may include various additional components such as, for example, screens or other means for holding the activated carbon in the compartment or additional purification devices such as filtration membranes, particulate filters, and the like. In some embodiments, the housing may include various components necessary to allow the filter to be integrated into a device such large-scale air purifiers in which fluid stream, such as air containing vehicle exhaust, flow from one compartment to another and pass through the filter during transfer. In particular, the filter may include an inlet port for introducing streams of fluid into the filter and an outlet port for dispensing the filtered streams of fluid from the filter. In some embodiments, the filter may include a removable means to connect to a gas source such as a pipe, hose, tube fittings, and the like at the inlet port.

### Examples

The following example was carried out according to embodiments of the present disclosure.

Several sorbents according to embodiments of the present disclosure were provided. TABLE 1 shows the composition of each of Comparative Example 1, Comparative Example 2, Example 1, and Example 2.

TABLE 1

| | Cu | Mo | SO₄ | Cl | KI | I |
|---|---|---|---|---|---|---|
| Example | (wt. %) | (wt. %) | (wt. %) | (wt. %) | (wt. %) | (wt. %) |
| Comparative | 9.80 | 1.80 | 3.41 | — | — | — |
| Example 1 | | | | | | |
| Comparative | 10.73 | 1.77 | 3.74 | — | — | 3.0 |
| Example 2 | | | | | | |
| Example 1 | 10.38 | 1.90 | | 1.31 | — | — |
| Example 2 | 9.18 | 1.70 | 3.96 | — | 3.31 | 2.53 |

As shown in TABLE 1, Comparative Example 1 is a base sorbent which does not include a halide, Comparative Example 2 has iodine (as I₂ ) added, Example 1 includes chloride, and Example 2 includes iodide.

TABLE 2

| | | | | | | Hg (min) |
|---|---|---|---|---|---|---|
| | | | | | | Start/End of |
| | | SO₂ | NH₃ | C₆H₁₂ | CCl₄ | Break- |
| Example | Chemistry | (min) | (min) | (min) | (min) | through |
| Comparative | Base | 62.7 | 43.0 | 46.0 | 22.8 | 64 |
| Example 1 | sorbent | | | | | |
| Comparative | Base | 42.2 | 47.9 | 44.3 | 16.3 | 3018 |
| Example 2 | sorbent | | | | | |
| | with iodine | | | | | |
| Example 1 | Sorbent | 68.2 | 45.3 | 49.9 | 18.9 | >2400 |
| | with | | | | | |
| | chloride | | | | | |
| Example 2 | Sorbent | 67.4 | 43.6 | 45.6 | 21.2 | 2442 |
| | with iodide | | | | | |

TABLE 2 shows a comparative sorbent which does not contain a halide as a reference (Comparative Example 1), and then the marked improvement for mercury removal with the chloride- and iodide-containing sorbents of the present disclosure (Examples 1 and 2). The sulfur dioxide, ammonia, cyclohexane, and carbon tetrachloride removal performances were maintained in the sorbents of the present disclosure compared to that of Comparative Example 1, indicating the ability of the presently disclosed sorbent material products to be utilized as multi-gas removal sorbents. Comparative Example 2 is a base sorbent material with iodine added, demonstrating that even the addition of iodine to a base sorbent material (without reformulating the sorbent material components) can lead to an improvement in mercury removal. The results of TABLE 2 show that the addition of a halide can significantly improve the mercury removal performance of the base sorbent material without sacrificing the removal performance of other contaminants, without wishing to be bound by theory.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A sorbent material product, comprising:
a sorbent material having a surface deposition comprising:
about 0.1 wt. % to about 10 wt. % of a halide,
about 0.1 wt. % to about 20 wt. % copper, and
about 0.1 wt. % to about 10 wt. % molybdenum.

2. The sorbent material product of claim 1, wherein the sorbent material comprises activated carbon, reactivated carbon, natural zeolite, synthetic zeolite, silica, silica gel, alumina, diatomaceous earths, and combinations thereof.

3. The sorbent material product of claim 1, wherein the halide comprises chloride, iodide, or a combination thereof.

4. The sorbent material product of claim 3, comprising about 0.1 wt. % to about 2 wt. % chloride.

5. The sorbent material product of claim 3, comprising about 0.4 wt. % to about 7 wt. % iodide.

6. The sorbent material product of claim 1, further comprising about 0.5 wt. % to about 5 wt. % sulfate.

7. The sorbent material product of claim 1, having a mercury breakthrough time of at least about 480 minutes.

8. The sorbent material product of claim 1, having a mercury breakthrough time of at least about 1000 minutes.

9. The sorbent material product of claim 1, having an ammonia breakthrough time of at least about 30 minutes.

10. The sorbent material product of claim 1, having a sulfur dioxide breakthrough time of at least about 40 minutes.

11. The sorbent material product of claim 1, having a cyclohexane breakthrough time of at least about 30 minutes.

12. The sorbent material product of claim 1, having a CCl₄ breakthrough time of at least about 10 minutes.

13. A method of preparing a sorbent material product, comprising:
forming an aqueous solution comprising a halide, copper, and molybdenum; and
contacting a sorbent material feedstock with the aqueous solution to form the sorbent material product.

14. The method of claim 13, wherein the sorbent material feedstock comprises activated carbon, reactivated carbon, natural zeolite, synthetic zeolite, silica, silica gel, alumina, diatomaceous earths, or combinations thereof.

15. The method of claim 13, wherein the sorbent material feedstock comprises activated carbon formed from bituminous coal, sub-bituminous coal, lignite coal, anthracite coal, peat, nut shells, pits, coconut, babassu nut, macadamia nut, dende nut, peach pit, cherry pit, olive pit, walnut shell, wood, bagasse, rice hulls, corn husks, wheat hulls, polymers, resins, petroleum pitches, or combinations thereof.

16. The method of claim 13, wherein the sorbent material product comprises about 0.1 wt. % to about 10 wt. % of a halide, about 0.1 wt. % to about 20 wt. % copper, and about 0.1 wt. % to about 10 wt. % molybdenum.

17. The method of claim 13, wherein the halide comprises chloride, iodide, or a combination thereof.

18. A method of removing mercury from a fluid stream, comprising:
contacting the fluid stream with a sorbent material product comprising a sorbent material having a first surface deposition comprising:
about 0.1 wt. % to about 10 wt. % of a halide, about 0.1 wt. % to about 20 wt. % copper, and about 0.1 wt. % to about 10 wt. % molybdenum.

19. The method of claim 18, wherein the sorbent material comprises activated carbon, reactivated carbon, natural zeolite, synthetic zeolite, silica, silica gel, alumina, diatomaceous earths, and combinations thereof.

20. The method of claim 18, wherein the halide comprises chloride, iodide, or a combination thereof.

21. The method of claim 18, wherein the sorbent material product has a mercury breakthrough time of at least about 480 minutes.

22. The method of claim 18, wherein the sorbent material product has a mercury breakthrough time of at least about 1000 minutes.

23. The method of claim 18, wherein the mercury is in the form of elemental mercury, mercury-containing compounds, or a combination thereof.

24. The method of claim 18, further comprising removing ammonia, sulfur dioxide, cyclohexane, CCl₄, or combinations thereof from the fluid stream.

25. The method of claim 18, wherein the sorbent material product has an ammonia breakthrough time of at least about 30 minutes.

26. The method of claim 18, wherein the sorbent material product has a sulfur dioxide breakthrough time of at least about 40 minutes.

27. The method of claim 18, wherein the sorbent material product has a cyclohexane breakthrough time of at least about 30 minutes.

28. The method of claim 18, wherein the sorbent material product has a CCl₄ breakthrough time of at least about 10 minutes.
